(19) United States
(12) Patent Application Publication
(10) Pub. No.: US 2026/0152023 A1
(43) Pub. Date: Jun. 4, 2026

(54) MECHANISM ADAPTABLE TO INSTALLATION OF ROTARY CUPS WITH MULTIPLE CALIBERS AND CUP TURNER

(71) Applicant: SHANGHAI HUIXUAN INTERNATIONAL TRADE CO., LTD., SHANGHAI (CN)

(72) Inventor: TUNHUI HONG, SHANGHAI (CN)

(21) Appl. No.: 18/964,024

(22) Filed: Nov. 29, 2024

(51) Int. Cl. B44D 3/00

(52) U.S. Cl. CPC B44D 3/00

(57) ABSTRACT

A mechanism adaptable to installation of rotary cups with multiple calibers and a cup turner are provided. The mechanism includes a cylinder configured to fixedly connect with a connecting axis and connecting rod mechanisms which are equidistantly distributed on an external portion of the cylinder. Each of the connecting rod mechanisms includes a first connecting rod, a second connecting rod, and a third connecting rod. When each second connecting rod is subjected to a contracting force, a corresponding torsion spring drives a corresponding first connecting rod and a corresponding third connecting rod to rotate inward with respect to corresponding hinge axes, so that a horizontal distance between each second connecting rod and an axis of the cylinder is less than an inner diameter radius of a rotary cup to be installed, allowing the rotary cups with different calibers to be inserted.

### TECHNICAL FIELD

The present disclosure relates to a technical field of DIY production, and in particular relates to a mechanism adaptable to installation of rotary cups with multiple calibers, and a cup turner.

### BACKGROUND

As people's concepts change, more and more people are fond of DIY items, the activity can make people relax, and the items made by DIY are also of commemorative significance to people. At present, in the field of DIY, DIY painting on cups is very popular, and thus cup turner that assist in cup painting have also emerged.

A current cup turner generally includes PVC pipes, cup turner foams sleeved at the ends of the PVC pipes, and a power source. Operators put cups on the cup turner foams, and the power source controls rotation speed of the PVC pipes, thereby controlling the rotation of the cups to achieve artistic creation. However, since the cups come in various calibers, many cup turner foams with different outer diameters need to be purchased to match the corresponding types of cups. Therefore, during the operation process, when changing cups, operators must replace the corresponding types of cup turner foams, which makes the operation cumbersome and also increases the cost. Secondly, after the cup turner foams having been used for a long time and being compressed, their original outer diameter shape cannot be restored, resulting in the cups not being firmly fixed. The cups may fall off during the working process, causing losses, so improvements are needed.

### SUMMARY

A main purpose of the present disclosure is to provide a mechanism adaptable to installation of rotary cups with multiple calibers and a cup turner, aiming to solve the technical problems of frequently replacing cup turner foams being troublesome to operate and increases the cost.

In order to achieve the above-mentioned purposes, the present disclosure provides a mechanism adaptable to installation of rotary cups with multiple calibers, including a cylinder configured to fixedly connect with a connecting axis and connecting rod mechanisms equidistantly distributed on an external portion of the cylinder. Each of the connecting rod mechanisms comprises a first connecting rod, a second connecting rod, and a third connecting rod. A front end of each second connecting rod is rotatably connected to a first end of a corresponding first connecting rod and a rear end of each second connecting rod is rotatably connected to a first end of a corresponding third connecting rod. A second end of each first connecting rod away from a corresponding second connecting rod is hinged to the external portion of the cylinder through a first hinge axis. A second end of each third connecting rod away from the corresponding second connecting rod is hinged to the external portion of the cylinder through a second hinge axis. Each first connecting rod and the corresponding third connecting rod have the same length and are arranged in parallel. A corresponding torsion spring is sleeved in a middle of each first hinge axis and/or a middle of each second hinge axis, and each torsion spring is configured to provide power to the corresponding first connecting rod and the corresponding second connecting rod. When each second connecting rod is subjected to a contracting force, the corresponding torsion spring drives the corresponding first connecting rod and the corresponding third connecting rod to respectively rotate inward with respect to a corresponding first hinge axis and a corresponding second hinge axis, so that a horizontal distance between each second connecting rod and an axis of the cylinder is less than an inner diameter radius of a rotary cup to be installed, allowing the rotary cup to be inserted. After the contracting force disappears, the corresponding first connecting rod and/or the corresponding third connecting rod rotates outward with respect to the corresponding first hinge axis and/or the corresponding second hinge axis under an action of the corresponding torsion spring, until a side of each second connecting rod away from the external portion of the cylinder abuts against an inner wall surface of the rotary cup.

The present disclosure further provides a cup turner, including a power source, a frame, and the mechanism adaptable to installation of rotary cups with multiple calibers as foregoing, the connecting axis in the mechanism is mounted on the frame, an output end of the power source is connected to the connecting axis, and the power source controls the connecting axis to rotate.

In the technical solution provided by the present disclosure, the connecting rod mechanisms are equidistantly distributed on the external portion of the cylinder. When each second connecting rod in the connecting rod mechanisms is subjected to the contracting force, each second connecting rod drives the corresponding first connecting rod and the corresponding third connecting rod to rotate inward with respect to corresponding hinge axes, so that the horizontal distance between each second connecting rod and the axis of the cylinder is less than the inner diameter radius of the rotary cup to be installed, allowing the rotary cups with different calibers to be inserted. This design does not need to frequently replace cup turner foams of different sizes to match corresponding rotary cups, greatly saving costs and simplifying operations. After the contracting force disappears, each first connecting rod and/or each third connecting rod rotates outward relative to corresponding hinge axes under the action of the corresponding torsion spring, so that the connecting rods on the connecting rod mechanisms have an outward-expanding tension. Since each first connecting rod and the corresponding third connecting rod are of the same length and arranged in parallel, during an expansion process of the connecting rod mechanisms, each second connecting rod in the connecting rod mechanism always translates outward parallel to the axis of the cylinder, ensuring that the side of each second connecting rod away from the external portion of the cylinder abuts against the inner wall surface of the rotary cup, thereby fixedly and stably attaching the rotary cup to the external portion of the mechanism, facilitating artistic creation by operators.

### BRIEF DESCRIPTION OF THE DRAWINGS

One or more embodiments are exemplarily illustrated by the corresponding drawings. These exemplary illustrations do not constitute limitations on the embodiments. Elements with the same reference numerals in the drawings represent similar elements. Unless otherwise stated, the figures in the drawings do not have a proportional limitation.

FIG. 1 illustrates a schematic diagram of a three-dimensional structure of the present disclosure;

FIG. 2 illustrates a schematic diagram of a structure of the connecting rod mechanism in a contracted state of the present disclosure;

FIG. 3 illustrates a schematic diagram of a structure of the connecting rod mechanism fixing the rotary cup of the present disclosure;

FIG. 4 illustrates a schematic diagram of the three-dimensional structure of the present disclosure from another angle;

FIG. 5 illustrates a sectional view of the cylinder of the present disclosure;

Reference numerals in the figures are as follows:
100—connecting axis; 200—rotary cup;
1—cylinder; 11—first connecting seat; 12—second connecting seat; 13—fixing component; 14—first channel; 15—second channel;
2—connecting rod mechanism; 21—first connecting rod; 211—first hinge axis; 212—first rotating axis; 213—first connecting plate; 22—second connecting rod; 221—first connecting block; 222—second connecting block; 223—elastic layer; 23—third connecting rod; 231—second hinge axis; 232—second rotating axis; 233—second connecting plate;
3—first torsion spring;
4—second torsion spring.

### DETAILED DESCRIPTION

In order to facilitate understanding of the application, a more detailed description of the application is provided below in connection with the drawings and specific embodiments. It should be noted that when an element is described as being “fixed to” another element, it may be directly on the other element, or there may be one or more centered elements therebetween. When an element is described as being “connected” to another element, it may be directly connected to the other element or there may be one or more centered elements therebetween. The terms “vertical”, “horizontal”, “left”, “right”, “inner”, “outer” and similar expressions used in this specification are for illustrative purposes only. In the description of the present disclosure, the terms “first” and “second” are used for descriptive purposes only and should not be construed as indicating relative importance or implicitly indicating the number of the indicated technical features. Thus, unless otherwise stated, features defined with “first” and “second” may explicitly or implicitly include one or more of such features; the meaning of “multiple” is two or more. The term “including” and any of its variations mean non-exclusive inclusion and may exist or add one or more other features, integers, steps, operations, units, mechanisms, and/or combinations thereof.

Furthermore, unless otherwise clearly specified and limited, the terms “installation”, “connected”, and “connecting” should be broadly understood. For example, they can be fixed connections, detachable connections, or integral connections; they can be mechanical connections or electrical connections; they can be directly connected or indirectly connected through an intermediate medium, or they can be the internal communication of two elements. All technical and scientific terms used in this specification have the same meanings as those commonly understood by technicians in the technical field of the present disclosure. The terms used in the description of the present disclosure are for the purpose of describing specific embodiments only and are not used to limit the present disclosure. The term “and/or” includes any and all combinations of one or more of the listed items.

Furthermore, the technical features involved in different embodiments of the present disclosure described below can be combined with each other as long as they do not conflict with each other.

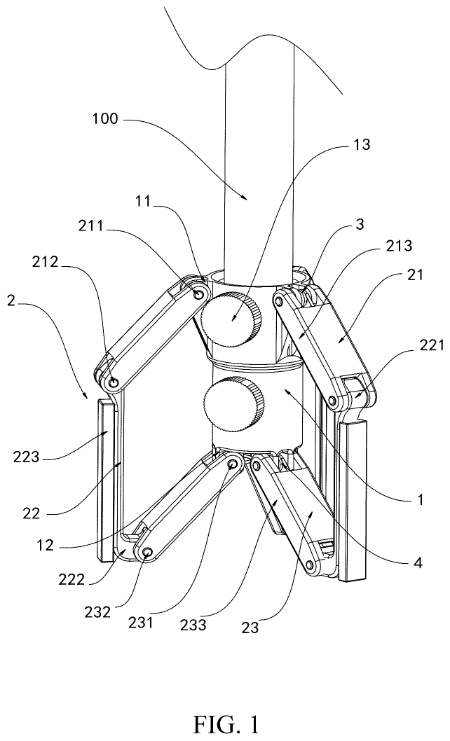

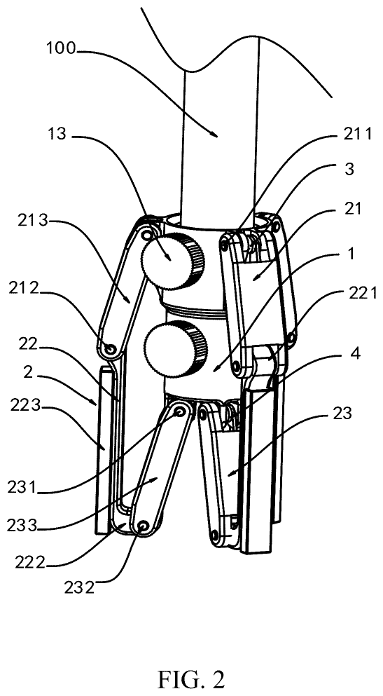

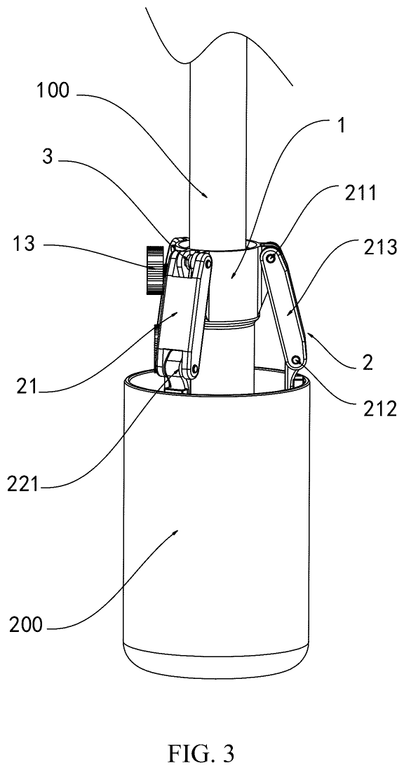

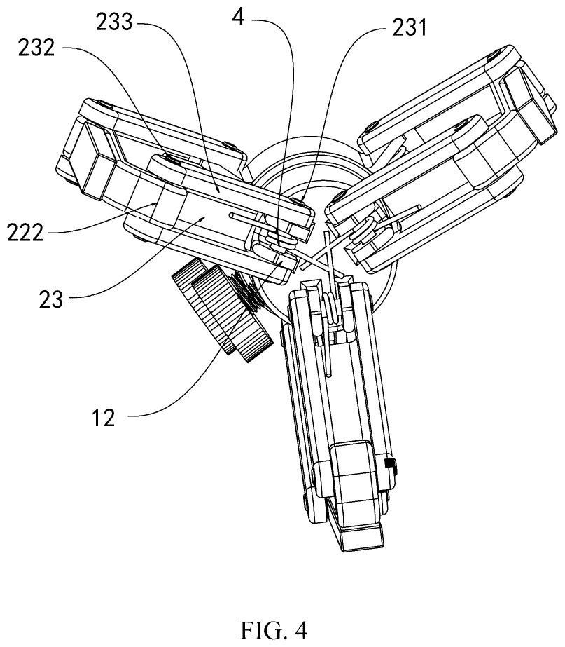

The present disclosure provides a mechanism adaptable to the installation of rotary cups with multiple calibers. Please refer to FIG. 1-FIG. 5, the mechanism includes a cylinder 1 configured to fixedly connect with a connecting axis 100 and multiple connecting rod mechanisms 2. The multiple connecting rod mechanisms 2 are equidistantly distributed on the outside of the cylinder 1. The connecting rod mechanism 2 and the outer wall of the cylinder 1 form a structure with a function of a parallelogram mechanism. Then, a torsion spring is provided at the connection between the connecting rod mechanism 2 and the cylinder 1. The torsion spring is used to provide power to the connecting rod in contact with it. When the connecting rod mechanism 2 is pressed, the connecting rod mechanism 2 will contract, making a horizontal distance between the outermost connecting rod of the connecting rod mechanism 2 and an axis of the cylinder 1 decrease until it is less than an inner diameter radius of a rotary cup 200 to be installed, allowing the rotary cups 200 with different calibers to be inserted. This design avoids frequent replacement of foams of rotary cup 200, saving costs and simplifying operations. After the rotary cup 200 is inserted, the operator releases the pressure on the pressing mechanism. Under the action of the torsion spring, the contracted connecting rod mechanism 2 now has an outward tension, making each outermost connecting rod of each connecting rod mechanism 2 abuts against the inner wall of the rotary cup 200, thereby fixedly and stably attaching the rotary cup 200 to the outside of the mechanism.

### First Embodiment

In the embodiment, please refer to FIG. 1, the number of the connecting rod mechanisms 2 is three. The three connecting rod mechanisms 2 are equidistantly distributed on the outside of the cylinder 1. The connecting rod mechanism 2 includes a first connecting rod 21, a second connecting rod 22, and a third connecting rod 23. A front end of the second connecting rod 22 is rotatably connected with a first end of the first connecting rod 21, and a rear end of the second connecting rod 22 is rotatably connected with a second end of the third connecting rod 23.

Specifically, in the embodiment, please refer to FIG. 1, a first connecting block 221 is provided at the front end of the second connecting rod 22. The first connecting block 221 is rotatably connected to the ends of two first connecting plates 213 away from a first connecting seat 11 through a first rotating axis 212, enabling the first connecting block 221 to rotate around the first rotating axis 212. Since a first limiting port for limiting a rotation angle of the first connecting block 221 is provided at the bottom of the first end of the first connecting rod 21 close to the first connecting block 221, the rotation of the first connecting block 221 is restricted. Secondly, a second connecting block 222 in a curved shape is provided at the rear end of the second connecting rod 22. The second connecting block 222 is rotatably connected to the ends of two second connecting plates 233 away from a second connecting seat 12 through a second rotating axis 232, enabling the second connecting block 222 to rotate around the second rotating axis 232. Similarly, a second limiting port for limiting a rotation angle of the second connecting block 222 is provided at the bottom of the first end of the third connecting rod 23 close to the second connecting block 222, also restricting the rotation of the second connecting block 222. Under the cooperation of the first connecting block 221 and the second connecting block 222, the movement of the second connecting rod 22 is restricted.

Essentially, since a second end of the first connecting rod 21 away from the second connecting rod 22 is hinged to the outside of the cylinder 1 through a first hinge axis 211, and a second end of the third connecting rod 23 away from the second connecting rod 22 end is hinged to the outside of the cylinder 1 through a second hinge axis 231, so that under the cooperation of the first connecting block 221 and the second connecting block 222, as well as the rotatable connection of the front end of the second connecting rod 22 to the first end of the first connecting rod 21 and the rotatable connection of the rear end of the second connecting rod 22 to the first end of the third connecting rod 23, and further considering that the first connecting rod 21 and the third connecting rod 23 have the same length and are arranged in parallel, the first connecting rod 21, the second connecting rod 22, the third connecting rod 23, and the outer wall of the cylinder 1 form a parallelogram mechanism. Therefore, according to the operating principle of the parallelogram mechanism, when the connecting rod mechanism 2 is operating, the second connecting rod 22 is always parallel to the axis of the cylinder 1, thereby facilitating the insertion with the rotary cup 200.

Further, in the embodiment, torsion springs are sleeved in the middle of both the first hinge axis 211 and the second hinge axis 231. The torsion springs are used to provide power to the connecting rods in contact with them. Specifically, the torsion springs include a first torsion spring 3 and a second torsion spring 4, that is, the first torsion spring 3 is sleeved in the middle of the first hinge axis 211, and the second torsion spring 4 is sleeved in the middle of the second hinge axis 231.

Please refer to FIG. 1-FIG. 4, a first connecting seat 11 is provided on the outside of the cylinder 1, and a first groove is provided on a side of the first connecting seat 11. First connecting plates 213 that protrude beyond the length of the first connecting rod 21 are respectively provided on both sides of the first connecting rod 21. The ends of the two first connecting plates 213 are hinged to the first connecting seat 11 through the first hinge axis 211. It should be noted that the first torsion spring 3 sleeved on the first hinge axis 211 is located within the first groove. Therefore, to ensure that the first torsion spring 3 can provide power to the first connecting rod 21 in contact with it, one end of the first torsion spring 3 is pressed against the outer wall of the cylinder 1, and the other end of the first torsion spring 3 is pressed against the surface of the first connecting rod 21 facing the cylinder 1. This setting enables the first connecting rod 21 to move outward under the action of the first torsion spring 3 after being compressed by an external force to approach the outer wall of the cylinder 1.

To ensure more stable operation of the connecting rod mechanism 2 and the persistent abutment of the second connecting rod 22 in the connecting rod mechanism 2 against the inner wall of the rotary cup 200, a second connecting seat 12 is also provided at the bottom of the cylinder 1. A second groove is provided at the bottom of the second connecting seat 12. Second connecting plates 233 that protrude beyond the length of the third connecting rod 23 are respectively provided on both sides of the third connecting rod 23. The ends of the two second connecting plates 233 are hinged to the second connecting seat 12 through the second hinge axis 231. Specifically, he second torsion spring 4 sleeved on the second hinge axis 231 is located within the second groove. One end of the second torsion spring 4 is located below an end of the torsion spring next to the connecting rod mechanism 2, and the other end of the second torsion spring 4 is pressed against the surface of the third connecting rod 23 facing the axis of the cylinder 1. This setting enables the third connecting rod 23 to move outward under the action of the second torsion spring 4 after being compressed by an external force to approach the outer wall of the cylinder 1.

Through the above double torsion spring setting, after the pressure on the connecting rod mechanism 2 is released, the second connecting rod 22 in the connecting rod mechanism 2 has a relatively strong outward thrust, that is, the side of the second connecting rod 22 away from the cylinder 1 can stably abut against the inner wall of the rotary cup 200, thereby stably fixing the rotary cup 200 on the second connecting rod 22 of each connecting rod mechanism 2.

To ensure more stable abutment of the second connecting rod 22 against the inner wall of the rotary cup 200 and to avoid damage to the inner wall of the rotary cup 200 by the second connecting rod 22, an elastic layer 223 parallel to the axis of the cylinder 1 is provided on the side of the second connecting rod 22 away from the outer wall of the cylinder 1. The elastic layer 223 abuts against the inner wall of the rotary cup 200.

Regarding the number of the transmission mechanisms, in fact, it can also be two, four, or so on. As long as the transmission mechanisms are equidistantly distributed on the outer wall of the cylinder 1 and the rotary cup 200 can be stably positioned after the second connecting rod 22 in each transmission mechanism abuts against the inner wall of the rotary cup 200.

Furthermore, please refer to FIG. 1, the cylinder 1 is fixed onto the connecting axis 100 by inserting it onto an end of the connecting axis 100. In the prior art, the cylinder 1 usually cooperates with PVC pipes of two different diameters, which provides a wider applicability. In the embodiment, the connecting axis 100 is a PVC pipe. Usually, PVC pipes commonly adopt two diameters, namely ½ inch and ¾ inch. The inner diameter of the existing cylinder 1 is fixed and it cannot be applicable to both of these two types of PVC pipes simultaneously.

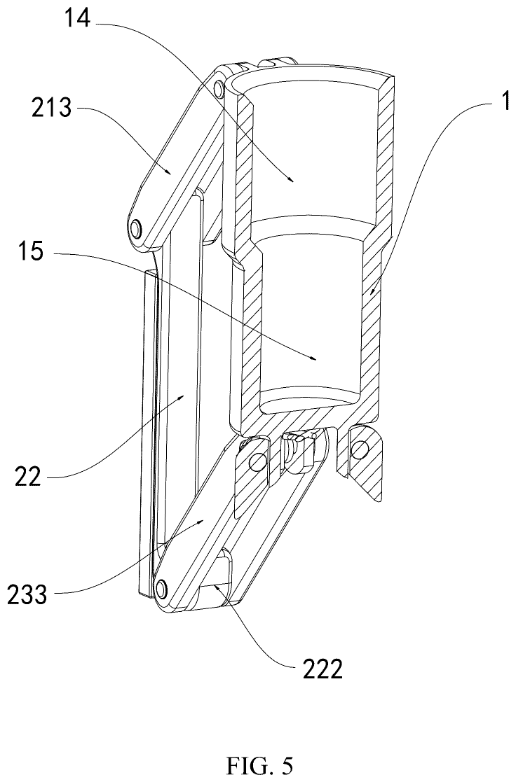

To solve the above problem, in the embodiment, please refer to FIG. 1 and FIG. 5, the inside of the cylinder 1 includes a first channel 14 and a second channel 15 connected to each other. The first channel 14 has an open end for the insertion of the connecting axis 100. Specifically, the vertical cross-section of the side wall of the cylinder 1 is in a stepped shape, and the surface of the stepped shape is inclined, which makes diameters of the first channel 14 and the second channel 15 different. Specifically, the diameter of the first channel 14 is larger than the diameter of the second channel 15. The above design enables the bottom ends of the PVC pipes of the two diameters to be inserted into the first channel 14 and the second channel 15 respectively, thereby fixing the cylinder 1 onto different connecting axis 100.

To ensure a more stable insertion connection between the cylinder 1 and the connecting axis 100, two fixing components 13 are provided on the outside of the cylinder 1. One fixing component 13 penetrates through the side wall of the cylinder 1 to restrict the end of the connecting axis 100 inserted into the first channel 14, and the other fixing component 13 penetrates through the side wall of the cylinder 1 to restrict the end of the connecting axis 100 inserted into the second channel 15. In the embodiment, the fixing component 13 includes a limiting screw. The limiting screw abuts against the outside of the end of the connecting axis 100, thereby enabling a stable insertion connection between the cylinder 1 and the connecting axis 100.

### Second Embodiment

The difference between the embodiment and the first embodiment is that no torsion spring is provided on the second hinge axis 231. Only the first hinge axis 211 is provided with a torsion spring. Only through the torsion spring on the first hinge axis 211 to provide power to the first connecting rod 21, making it drive the second connecting rod 22 to translate, so that the elastic layer 223 on the second connecting rod 22 abuts against the inner wall of the rotary cup 200, thereby stabilizing the position of the rotary cup 200.

### Third Embodiment

The difference between the embodiment and the first embodiment is that no torsion spring is provided on the first hinge axis 211. Only the second hinge axis 231 is provided with a torsion spring. Only through the torsion spring on the second hinge axis 231 to provide power to the third connecting rod 23, making it drive the second connecting rod 22 to translate, so that the elastic layer 223 on the second connecting rod 22 abuts against the inner wall of the rotary cup 200, thereby stabilizing the position of the rotary cup 200.

In conclusion, through the cooperation of the connecting rod mechanism 2 and the torsion springs, the mechanism can fix the rotary cups 200 with different calibers. Secondly, the torsion springs have good elastic durability, so the connecting rod mechanism 2 will not lose its tension over a long period of use, which would otherwise cause the support of the second connecting rod 22 to become ineffective.

The application also provides a cup turner, the cup turner of the rotary cup 200 includes a power source (not shown), a frame (not shown), and the aforementioned mechanism. The connecting axis 100 in the mechanism is mounted on the frame, an output end of the power source is connected to the connecting axis 100, and the power source controls the rotation of the connecting axis 100, thereby controlling the rotation of the rotary cup 200, facilitating the artistic creation by operators.

The above embodiments are only used to illustrate the technical solutions of the present disclosure, rather than to limit it. Under the thinking of the present disclosure, the technical features in the above embodiments or different embodiments can also be combined, and the steps can be implemented in any order. There are also many other changes in different aspects of the present disclosure as described above. For the sake of brevity, they are not provided in detail. Although the present disclosure has been described in detail with reference to the foregoing embodiments, those of ordinary skill in the art should understand that they can still modify the technical solutions recorded in the foregoing embodiments, or equivalently replace some of the technical features; and these modifications or replacements do not cause the essence of the corresponding technical solutions to deviate from the scope of the technical solutions of the various embodiments of the present disclosure.

1. A mechanism adaptable to installation of rotary cups with multiple calibers, comprising:
a cylinder, configured to fixedly connect with a connecting axis; and
connecting rod mechanisms, equidistantly distributed on an external portion of the cylinder;
wherein each of the connecting rod mechanisms comprises a first connecting rod, a second connecting rod, and a third connecting rod;
a front end of each second connecting rod is rotatably connected to a first end of a corresponding first connecting rod and a rear end of each second connecting rod is rotatably connected to a first end of a corresponding third connecting rod;
a second end of each first connecting rod away from a corresponding second connecting rod is hinged to the external portion of the cylinder through a first hinge axis;
a second end of each third connecting rod away from the corresponding second connecting rod is hinged to the external portion of the cylinder through a second hinge axis;
each first connecting rod and the corresponding third connecting rod have the same length and are arranged in parallel;
a corresponding torsion spring is sleeved in a middle of each first hinge axis and/or a middle of each second hinge axis, and each torsion spring is configured to provide power to the corresponding first connecting rod and the corresponding second connecting rod;
when each second connecting rod is subjected to a contracting force, the corresponding torsion spring drives the corresponding first connecting rod and the corresponding third connecting rod to respectively rotate inward with respect to a corresponding first hinge axis and a corresponding second hinge axis, so that a horizontal distance between each second connecting rod and an axis of the cylinder is less than an inner diameter radius of a rotary cup to be installed, allowing the rotary cup to be inserted; and
after the contracting force disappears, the corresponding first connecting rod and/or the corresponding third connecting rod rotates outward with respect to the corresponding first hinge axis and/or the corresponding second hinge axis under an action of the corresponding torsion spring, until a side of each second connecting rod away from the external portion of the cylinder abuts against an inner wall surface of the rotary cup.

2. The mechanism adaptable to installation of rotary cups with multiple calibers as claimed in claim 1, wherein each torsion spring comprises a first torsion spring, a first connecting seat is disposed on the external portion of the cylinder, a first groove is defined on a side of the first connecting seat, and each first torsion spring is disposed within the first groove;
two first connecting plates protruding beyond a length of each first connecting rod are respectively disposed on both sides of the corresponding first connecting rod, first ends of corresponding two first connecting plates are hinged to the first connecting seat through the corresponding first hinge axis, a first end of each first torsion spring is pressed against the outer wall of the cylinder, and a second end of each first torsion spring is pressed against a surface of the first connecting rod facing the cylinder.

3. The mechanism adaptable to installation of rotary cups with multiple calibers as claimed in claim 1, wherein each torsion spring further comprises a second torsion spring, a second connecting seat is disposed at a bottom of the cylinder, a second groove is defined at a bottom of the second connecting seat, and each second torsion spring is disposed within the second groove;
two second connecting plates protruding beyond a length of each third connecting rod are respectively disposed on both sides of the corresponding third connecting rod, first ends of corresponding two second connecting plates are hinged to the second connecting seat through the corresponding second hinge axis, a first end of each second torsion spring is disposed below an end of a corresponding torsion spring an adjacent connecting rod mechanism of the connecting rod mechanisms, and a second end of each second torsion spring is pressed against a surface of the third connecting rod facing the cylinder.

4. The mechanism adaptable to installation of rotary cups with multiple calibers as claimed in claim 1, wherein an elastic layer parallel to the axis of the cylinder is disposed on the side of each second connecting rod away from the external portion of the cylinder.

5. The mechanism adaptable to installation of rotary cups with multiple calibers as claimed in claim 2, wherein a first connecting block is disposed at the front end of each second connecting rod, each first connecting block is rotatably connected to second ends of the corresponding two first connecting plates away from the first connecting seat through a first rotating axis, and a first limiting port for limiting a rotation angle of each first connecting block is defined at a bottom of the first end of the corresponding first connecting rod.

6. The mechanism adaptable to installation of rotary cups with multiple calibers as claimed in claim 5, wherein a curved second connecting block is disposed at the rear end of each second connecting rod, each curved second connecting block is rotatably connected to second ends of the corresponding two second connecting plates away from the second connecting seat through a second rotating axis, and a second limiting port for limiting a rotation angle of each curved second connecting block is defined at a bottom of the second end of the corresponding third connecting rod.

7. The mechanism adaptable to installation of rotary cups with multiple calibers as claimed in claim 1, wherein the cylinder internally comprises a first channel and a second channel communicated to each other, the first channel has an open end for insertion of the connecting axis, and a diameter of the first channel is larger than a diameter of the second channel.

8. The mechanism adaptable to installation of rotary cups with multiple calibers as claimed in claim 7, wherein two fixing components are disposed on the external portion of the cylinder, a first one of the two fixing components penetrates through a side wall of the cylinder to limit a first end of the connecting axis inserted into the first channel,, and a second one of the two fixing components penetrates through the side wall of the cylinder to limit a second end of the connecting axis inserted into the second channel.

9. The mechanism adaptable to the installation of rotary cups with multiple calibers as claimed in claim 8, wherein each of the two fixing component comprises a limiting screw.

10. A cup turner, comprising:
a power source;
a frame; and
the mechanism adaptable to installation of rotary cups with multiple calibers as claimed in claim 1;
wherein the connecting axis in the mechanism is mounted on the frame, an output end of the power source is connected to the connecting axis, and the power source controls the connecting axis to rotate.
